(19) United States
(12) Patent Application Publication
(10) Pub. No.: US 2010/0028634 A1
(43) Pub. Date: Feb. 4, 2010

(54) METAL OXIDE COATINGS FOR ELECTRICALLY CONDUCTIVE CARBON NANOTUBE FILMS

(76) Inventors: Evgeniya P. Turevskaya, Franklin, MA (US); David H. Landis, Barrington, RI (US); David Alexander Britz, Cambridge, MA (US); Paul J. Glatkowski, Littletown, MA (US)

Correspondence Address: REMENICK PLLC, 1025 THOMAS JEFFERSON STREET, NW, WASHINGTON, DC, 20007, US

(21) Appl. No.: 11/831,748

(22) Filed: Jul. 31, 2007

Related U.S. Application Data
(60) Provisional application No. 60/834,281, filed on Jul. 31, 2006.
(60) Provisional application No. 60/826,783, filed on Sep. 25, 2006.

(51) Int. Cl. B32B 7/02; B32B 9/00; B32B 27/32; B32B 17/06; B32B 27/36; B32B 27/38; B32B 27/40; B32B 27/30; B32B 27/28; B05D 5/12

(52) U.S. Cl. 428/213; 428/702; 428/220; 428/432; 428/480; 428/412; 428/423.1; 428/421; 428/413; 428/523; 427/108

(57) ABSTRACT

This invention are directed to methods and compositions preferably comprising non-silicate metal oxides as a treatment for transparent electrically conductive carbon nanotube coatings that prevents resistance changes during exposure to environmental conditions; both chemical effects (for example, water, heat, light, or other compounds) and physical effects (for example, abrasion, scratch, adhesion). The protective properties instilled by these coatings occur preferably through the careful selection of the appropriate metal oxide depending on the application.

### REFERENCE TO RELATED APPLICATIONS

This application claims priority to U.S. Provisional Application No. 60/834,281, filed Jul. 31, 2006, and U.S. Provisional Application No. 60/826,783, filed Sep. 25, 2006, both entitled “Metal Oxide Coatings for Nanotube Conductive Films,” and both of which are specifically and entirely incorporated by reference.

### RIGHTS IN THE INVENTION

This invention was made, in part, with support from the United States Department of Energy, under funding from Grant No. DE-FG36-05GO85035. Accordingly, the Unites States government has certain rights in this invention.

### BACKGROUND

1. Field of Invention

This invention is directed to compositions and methods of creating and maintaining the electrical conductivity of carbon nanotubes transparent electrically conductive layers and films by application of metal oxide materials in to the carbon nanotube network. The resulting transparent conductive layers are useful for forming electrodes and patterned circuits in a wide range of consumer electronic devices such as, but not limited to, touch screens, information displays, solar cells, sensors, transducers and other devices demanding the unique combination of properties afforded by these layers.

2. Description of the Background

Successful and practical sol-gel coatings today have been realized in electronics, optics, automotive, chemical and food industries. Among these materials one can identify ferro- and piezo-dielectrics, solid electrolytes, refractory materials, membranes, protective coatings and films with special optical and electro-physical properties. Carbon nanotube (CNT) containing conductive layers are coated with metal oxides using advantages presented by sol-gel method for creating composites with exceptional performance characteristics (see e.g. U.S. Pat. Nos. 4,874,462; 5,137,749; 6,355,821; 6,965,006; 6,988,925; 6,596,807; 7,060,241; 7,118,693; U.S. Patent Publication Nos. 20060113510; 20060111008; 20050221016; 20050209392 and Turova, Turevskaya, Kessler, and Yanovskaya, The Chemistry of Metal Alkoxides, Kluwer Academic Publishers, Boston, 2002) (all of which are hereby specifically and entirely incorporated by reference).

Numerous electronic devices require electrical conductors which are optically transparent to visible light. The transparent electrical conductors function by transmitting electrical power to operate user interfaces like touch screens or to send a signal to a pixel in an LCD display. Transparent conductors are an essential component in many optoelectronic devices including flat panel displays, touch screens, electroluminescent lamps, solar panels, “smart” windows, and OLED lighting systems. In all these applications, the user must see through the conductive layer to perform an operation. In addition, transparent patterned conductors are valuable in making biometric identification cards, e.g., Smart cards in which the information is stored in or transferred thought the conductive layer. The use of transparent conductive layers in such cards is advantageous for security purposes since it is difficult to find the information.

Today most transparent electrodes are made from transparent conducting oxides, such as indium tin oxide (ITO), and have been the preferred choice for four decades. ITO is applied to an optically transparent substrate by vacuum deposition and then patterned using costly photolithographic techniques to remove excess coating and form the wire and electrodes. Both of the processes are difficult and expensive to scale up to cover large areas. ITO also has some rather significant limitations: 1) ITO films are brittle (mechanical reliability concern for flexible applications such as in plastic displays, plastic solar voltaic, and wearable electrical circuitry); and 2) ITO circuits are typically formed by vacuum sputtering followed by photolithographic etching (fabrication cost may be too high for high volume/large area applications).

Efforts have been made to provide transparent electrodes to replace ITO film. A typical example is a suspension of ITO particles in a polymer binder. However, this ITO-filled system cannot match the electrical conductivity of a continuous ITO film. Furthermore, transparent conductive polymer materials are now being developed. These polymers typically require dopants to impart conductive properties and are applied on a substrate using screen printing or an ink jet application technique. Although they are still at a development stage, and have yet to reach the conduction level of an ITO film, the presence of dopants has an adverse effect on making these materials sensitive to environmentally induced changes in resistance and transparency.

Future electronic devices are limited in function and form by the current materials and processes utilized to create electrically conductive transparent layers. The need for electrically conductive optically transparent coatings and films continues to increase. These films and coatings need to be more transparent and at least equally conductive. Such films are preferably processed using large area patterning and ablative techniques, as well as being flexible and wholly low in cost.

### SUMMARY OF INVENTION

The present invention overcomes the problems and disadvantages associated with existing nanotube coatings and designs, such as changes to electrical resistance during or after exposure to environmental conditions, like humidity, high temperature, and/or electromagnetic radiation exposure such as UV light. These are commonly experienced environmental conditions for typical electronic devices including consumer electronics such as touch screen-based PCs or PDAs and in other electro-optical devices such as solar cells and information displays which may all comprise nanotubes coatings as electrodes or to form conductive circuits.

It was surprisingly discovered that specific inorganic metal oxides, and combinations thereof, can be formed over a preexisting network of carbon nanotubes, preferably single-walled carbon nanotubes, producing novel materials with unique properties including improved stability of electrical, chemical and physical characteristics upon exposure to a plethora of environmental conditions.

One embodiment of the invention is directed to a composite comprising an electrical network of carbon nanotubes and a network of amorphous metal oxide, as an insular, wherein the composite is electrically stable. In preferred embodiments, the composite has a surface resistance that undergoes a less than 25% change upon exposure to temperatures of 80° C. or greater, electromagnetic radiation, UV radiation, a relative humidity of 15% or greater, physical stress, chemical stress, mechanical stress. In preferred embodiments, the surface resistance of the composite undergoes a less than 20% change, less than 15% change, less than 10% change, or less than 5% change. IN another preferred embodiment, the surface resistance undergoes no detectable or significant change.

Another embodiment is directed to a composite that has a thickness, a length and a width, and wherein the length to thickness ratio is 100,000 or greater. In preferred embodiments, the width to thickness ratio is greater than 100,000. In preferred embodiments, the thickness of the composite is less than 500 nm, less than 200 nm, or less than 100 nm.

Another embodiment is directed to a composite, wherein the carbon nanotubes of the composite are substantially uniformly distributed, substantially aligned, and/or are substantially disentangled. In certain embodiments, the carbon nanotubes of the composite have aspect ratios of 1-100, 100-1000 or greater than 1000.

Another embodiment is directed to composites that have an optical transparency of greater than 60%, greater than 70%, greater than 80%, greater than 90%, greater than 95% or about 100%. Another embodiment is directed to a composite having a surface resistance of less than 10⁶ Ω/□, less than 10⁵ Ω/□, less than 10⁴ Ω/□, less than 10³ Ω/□, less than 10² Ω/□, or less than 10 Ω/□.

Another embodiment is directed to composites comprising a metal oxide formed from a non-silicate oxide. In preferred embodiments, the non-silicate oxide comprises oxides of Ti, Al, Zn, Zr, Nb, In, Sn, Ta, Hf, La, or combinations thereof. Preferably, the non-silicate oxide comprises an oxide of Ti, Al, and ZN.

Another embodiment is directed to a composite comprising a network of carbon nanotubes and a network of amorphous metal oxide that are continuous and porous. In a preferred embodiment, the continuous and porous network of carbon nanotubes interpenetrates with the continuous and porous network of amorphous metal oxide to form a continuous and porous composite network.

Another embodiment is directed to a composite comprising a substrate selected from the group consisting of polymer film, glass substrate, polymer, polyester, polycarbonate, polyolefin, polyurethane, acrylate, epoxy, fluorocarbon elastomer, plastic, thermoplastic, polyethylene tetraphthalate, polyethylene naphthalate, and combinations thereof.

Another embodiment is directed to a composite comprising one or more layers containing the amorphous metal oxide. Preferably, the one or more layers containing the amorphous metal oxide have a surface resistance of greater than 10⁷ Ω/□, greater than 10¹⁰ Ω/□, greater than, greater than 10¹² Ω/□, or greater than 10²⁰ Ω/□. Preferably, the composite comprises a separate layer containing the carbon nanotubes, and wherein the surface resistance of the one or more layers containing the amorphous metal oxide to surface resistance of the layer containing the carbon nanotubes ratio is greater than 10, greater than 10², greater than 10⁵, or greater than 10⁷.

Another embodiment is directed to a composite comprising a polymer. Preferably, the polymer is selected from a group consisting of polyester, polyurethane, polyolefin, fluoroplastic, fluoroelastomer, thermoplastic elastomer, polyvinylidene fluoride, polyvinyl fluoride, polychlorotrifluoroethylene, polyvinylalkyl vinyl ether, a melamine/acrylic copolymer, UV curable epoxy, a copolymer or polymer mixture, and combinations thereof.

Another embodiment is directed to a composition comprising a network of carbon nanotubes and a network of porous amorphous, non-silicate metal oxides, wherein said network of carbon nanotubes and said network of porous metal oxides form a composite, and wherein the composite has a thickness of less than 500 nm, less than 200 nm, or less than 100 nm. Preferably, the network of carbon nanotubes is porous and continuous and interpenetrates with the network of porous metal oxides to form a porous and continuous composite network.

Another embodiment is directed to a composition deposited as a film on a substrate. Preferably, the substrate is selected from the group consisting of polymer film, glass substrate, polymer, polyester, polycarbonate, polyolefin, polyurethane, acrylate, epoxy, fluorocarbon elastomer, plastic, thermoplastic, polyethylene tetraphthalate, polyethylene naphthalate, and combinations thereof.

Another embodiment is directed to a composition comprising a polymer. Preferably, the polymer is selected from a group consisting of polyester, polyurethane, polyolefin, fluoroplastic, fluoroelastomer, thermoplastic elastomer, polyvinylidene fluoride, polyvinyl fluoride, polychlorotrifluoroethylene, polyvinylalkyl vinyl ether, a melamine/acrylic copolymer, UV curable epoxy, a copolymer or polymer mixture, and combinations thereof.

Another embodiment is directed to a method of forming an electrically conductive and transparent film comprising: providing an electrically conductive network of carbon nanotubes; and depositing a non-silicate alkoxide in the form of a sol comprising an alcohol and an acid onto the network, wherein the metal alkoxide undergoes hydrolysis to be converted to a metal oxide. Preferably, the method further comprises air drying the film. Preferably, the depositing of the metal alkoxide comprises dip coating the network into a solution containing the metal alkoxide. Preferably, the method further comprises heating the film at a temperature of between approximately 60 and 200 degrees Celsius. Preferably, the heating is performed for more than 15 minutes, more than 30 minutes, more than 1 hour, more than 1.5 hours, more than 2 hours, more than 2.25 hours or more than 2.5 hours.

Another embodiment is directed to a method further comprising depositing a polymeric coating on the composite. Preferably, the polymeric coating comprises polyester, polyurethane, polyolefin, fluoroplastic, fluoroelastomer, thermoplastic elastomer, polyvinylidene fluoride, polyvinyl fluoride, polychlorotrifluoroethylene, polyvinylalkyl vinyl ether, a melamine/acrylic copolymer, UV curable epoxy, a copolymer or polymer mixture, or combinations thereof. Preferably, the polymeric coating is adhesive. Preferably, the polymeric coating prevents degradation of the composite due to mechanical or physical stress. Preferably, the polymeric coating has an index of refraction which matches adjacent layers.

Another embodiment is directed to a method, wherein the depositing of the sol is repeated after the air drying.

Another embodiment is directed to a method, wherein surface resistance of the film undergoes a less than 25% change upon exposure to temperatures of 80° C. or greater, electromagnetic radiation, UV radiation for more than 100 hours, a relative humidity of 15% or greater, physical stress, chemical stress, mechanical stress. Preferably, the surface resistance undergoes a less than 20% change, less than 15% change, less than 10% change, or less than 5% change. Preferably, the surface resistance undergoes no detectable or significant change.

Another embodiment is directed to a method, wherein the non-silicate alkoxide comprises Ti, Al, Zn, Zr, Nb, In, Sn, Ta, Hf, La, or combinations thereof. Preferably, the non-silicate alkoxide comprises Ti—Al—Zn. Preferably, the metal oxide is amorphous.

Another embodiment is directed to a composite formed by the method or methods according to embodiments of this invention.

Another embodiment is directed to a method of patterning an electrically conductive and transparent coating comprising depositing a layer of carbon nanotubes onto a film; selectively depositing a sol-gel solution onto a portion of the layer of carbon nanotubes; heating the film comprising the carbon nanotubes and the sol-gel; and removing a portion of the carbon nanotubes onto which the sol-gel was not deposited to form a pattern.

Other embodiments and advantages of the invention are set forth in part in the description, which follows, and in part, may be obvious from this description, or may be learned from the practice of the invention.

### DESCRIPTION OF THE FIGURES

FIG. 1 depicts sample preparation steps according to certain embodiments of this invention.

FIG. 2 depicts resistance change over time in hours for Ti—Al—Zn Oxide during a UV exposure test in certain embodiments.

FIG. 3 depicts resistance change over time in hours for Ti—Al—Zn Oxide during heat exposure in certain embodiments.

### DESCRIPTION OF THE INVENTION

The utility of transparent conductive coatings for any application, such as touch screens, strongly depends on meeting a broad set of performance requirements. The primary requirements are transparency and conductivity; however to make the materials useful, other properties must be imparted, such as mechanical adhesion to the substrate, abrasion resistance, coating uniformity, stability under radiation from the sun, stability to high temperatures experienced by the coating during processing and in use, among many others.

Single walled carbon nanotubes (SWNT or SWCNT) can be made into excellent transparent conductive layers with the unique combination of flexibility, ease of deposition, ease of patterning, low cost, environmental friendliness, and excellent compatibility with other layers. However, the electrical conductivity of a pure layer of SWCNT or a composite layer of SWCNT with a matrix material, typically comprising polymers, suffers from reversible and nonreversible reduction in electrical performance when exposed to the environmental conditions routinely found in most applications.

For example, a layer of SWCNT formed on a surface and then over-coated with a polymeric layer for protection from abrasion will experience a reduction in conductivity across the surface of the layer when exposed to elevated temperatures. The degree of reduction in electrical properties depends on many factors including, but not limited to, time, temperature, polymer type, thickness, and substrate type. The same degradation is observed for said coating upon exposure to a humid environment, especially a hot and humid environment. Most of the degradation is not reversible or recoverable. Only one part of the change in conductivity is related to a typical metal's linear increase to heat, which is reversible. The balance of the changes induced by heat and or humidity is irreversible and permanent. Furthermore, the effect continues for long periods of time with conductivity still being reduced even after 1,000 hours. Consequently, the resulting changes in conductivity make the use of SWCNT as an electrode in devices impractical and uncompetitive with existing technology.

The same type of degradation is observed when nanotube coatings are exposed to UV radiation, as when applied as an electrode in solar cells. The electrical conductivity of SWCNT is reduced when exposed to bright light especially blue (470 nm) through UV (<320 nm) light. For outdoor applications this makes the use of coating containing SWCNT unacceptable without filtering out these wavelengths, which adds cost and complexity to the device.

The cause for these changes in performance are numerous and are likely due to changes in nanotube network morphology, chemical doping by oxygen and water, contact corrosion or oxidation, among many others.

Vincent, P. et al., (J. of Non-Crystalline Solids 311 (2002), pg. 130-137) and Ning, J., et al., (Ceramics Internat. 30 (2004) pg. 63-67) both prepared composites of multi-walled CNTs in a metal oxide sol-gel matrix. However, although multiwalled CNTs are easier to manipulate than single-walled CNTs, resulting composites have low optical transparency and low conductivity, and multi-walled nanotubes do not provide sensitivity to environmental changes.

Dong, W., et al., (Science and Tech, of Adv. Materials 4 (2003), pg. 3-11) prepared vanadium oxide aerogels using suspensions of SWNT's; however these where produced by compounding CNT into the metal oxide and suffered from poor optical and electrical performance. Furthermore, since an aerogel was formed little or no environmental protection was afforded by these methods.

Boussaad, Salah et al. (US Publication 20060240238; incorporated by reference) discloses metal oxide composites containing highly homogeneous dispersions of single-walled carbon nanotubes prepared using sol-gel methods and shows these to be electrically conductive with some optical transparency. However the methods employed produced composite coatings with a poor combination of low transparency and low electrical conductivity resulting from the direct dispersion of low amounts (<2%) of CNT into the sol gel before forming composite. The low conductivity is in part due to use of silica based sol-gels, which are known to reduce the electrical performance of nanotube composites when compared to the use of other matrix materials or metal oxides employed by embodiments of the present invention.

The Boussaad nanotube composites are formed by dispersing CNT, using surfactants, into the sol gel material at low loading levels. Higher concentrations are not possible using the disclosed methods and are limited by rheological and thermodynamic barriers. The method yields a conductive layer with high electrical resistance and low transparency and thus is of limited utility compared to the present invention. The resulting materials' high electrical resistance means that changes in resistance due to environmental and mechanical exposure are less important to the performance of any product or device made from said material. It is therefore unlikely that Boussaad would be aware that the use of silicate sol gels reduced the overall electrical performance of the composites and that the silicate matrix provides little protection from environmental exposure.

For example, a coating having 10⁶ Ohms/square resistivity may become damaged by exposure to sunlight, heat, humidity, or abrasion and exhibit a resistivity change of 50%. The damaged coating is still functional as a dissipative coating since the resistance is still 1.5×10⁶ Ohms/sq, well within the functional range of devices in this range of resistance. However, for most commercial uses of transparent conductive coatings, the required resistivity range is much lower, for example, 50-300 Ohms/square. In this useful range, a 50% change in resistivity resulting from environmental exposure results in a failed device.

There is a need therefore for environmentally stable conductive materials comprising single walled carbon nanotubes for use in devices. The importance of identifying specific protective binders or coatings for the CNT layer is pronounced and of great need to fully exploit the potential of nanotube in the majority of devices in the marketplace. Further, an efficient, rapid and cost-effective method for stabilizing SWCNT layers from the deleterious effects of exposure to common environment conditions would be of great utility.

The present invention provides a novel solution to overcoming all these problems by the addition of specific metal oxides to the conductive network formed from carbon nanotubes using simple wet coating techniques. A combination of these materials can impart the environmental stability required in many applications and allow the exploitation and improvement of other remarkable properties of SWCNT. The additive materials provided not only satisfy multiple performance requirements, but also, as it was surprisingly discovered, enhance the optical and electrical performance of the CNT layer.

Specifically, this invention discloses methods and materials which, when added to a conductive network of nanotubes, increase transparency and decrease resistivity of the network. More specifically, the creation of metal oxide compounds as a binder or additive to the CNT network greatly improves resistance and transmission performance while reducing the deleterious effects of UV light exposure, humidity, heat exposure and other environmental and physical damage.

In a preferred embodiment, the nanotubes are oriented by exposing the films to a shearing, stretching, or elongating step or the like, e.g., using conventional polymer processing methodology. Such shearing-type processing refers to the use of force to induce flow or shear into the film, forcing a spacing, alignment, reorientation, disentangling etc. of the nanotubes from each other greater than that achieved for nanotubes simply formulated either by themselves or in admixture with polymeric materials. Oriented nanotubes are discussed, for example in U.S. Pat. No. 6,265,466, which is incorporated herein by reference in its entirety. Such orientation and disentanglement can be achieved by extrusion techniques, application of pressure more or less parallel to a surface of the composite, or application and differential force to different surfaces thereof, e.g., by shearing treatment by pulling of an extruded plaque at a variable but controlled rate to control the amount of shear and elongation applied to the extruded plaque. It is believed that this orientation results in superior properties of the film, e.g., enhanced conductivity. SWNT form ropes or networks of ropes better than multi-walled carbon nanotubes or carbon nanotubes with an outer diameter of greater than 3.5 nm. The characteristic of roping is a key aspect to the ability to infiltrate the network with binder.

Preferably, the nanotubes are oriented parallel to the electric field. This type of orientation is advantageous since carbon nanotubes have a high aspect ratio compared with fibers used by the prior art since nanotubes have an aspect ration of greater than 1,000, whereas the aspect ratio for prior art nickel-coated graphite fibers, for example, is 100 or less. In preferred embodiments, the carbon nanotubes have aspect ratios of 1-100, 100-1000 or above 1000.

It was surprisingly discovered that specific inorganic metal oxides, and combinations thereof, can be formed over networks of carbon nanotubes, producing novel materials with unique properties including improved stability of electrical, chemical and physical characteristics upon exposure to a plethora of environmental conditions. Embodiments of the present invention are directed to binders, films, coatings, protective layers, and topcoats comprising metal oxides, and to methods of forming same and products comprising same.

In certain embodiments, a film former (sol) comprising one or more metal alkoxides is deposited onto a carbon nanotube (CNT) layer or film. Upon deposition, the metal alkoxide is converted to oxoalkoxides or hydrated metal oxides as it undergoes hydrolysis. Baking or heating of such films leads to removal of hydroxyl groups, solvent, water, and other materials, leading to formation of metal oxide films. The metal oxide interpenetrates the CNT network to form a metal oxide-CNT composite. If a substrate is present, the metal oxide preferably also penetrates through the CNT network to the substrate and binds the CNT layer to the substrate adding the additional functionality of toughness and durability against scratches and abrasion. The metal oxide-CNT composite can be preferably coated with additional layers of the metal oxide or with other binders to add further protection and the ability to be compatible with other layer(s) in the device structure (see U.S. Patent Publication Application Nos. 20060113510 and 20050209392).

Embodiments are directed to metal oxides as a treatment, such as a coating, to prevent resistance change during exposure to environmental conditions; both chemical effects (for example, water, heat, light (UV), other compounds) and physical effects (for example, abrasion, scratch, adhesion). The protective properties instilled by these coatings occur preferably through the careful selection of the appropriate metal oxide depending on the application. Often times, a combination of protective properties are needed, for example, temperature and UV protection, so a binary or ternary blend of metal oxide precursors would be selected, or a sequential layering would be made to achieve the necessary stability for a given device and/or application. Zinc oxide is preferably for UV protection, but provides little protection alone for heat stability in certain embodiments; zinc oxide can, however, be combined beneficially with Ti or Al or both to achieve protective properties against heat, water, light, and physical effects, in various embodiments.

Once the CNT and metal oxide coating are in place, additional coating(s) can preferably be added to the porous network, depending on whether the network is thin enough to be porous. The additional coating is preferably polymeric and preferably adds additional scratch resistance or preferably acts as an interface modifier, such as an adhesive layer which serves to bond the next part of the device.

Metal oxide coating on a CNT network is multifunctional; it improves one or more of the following properties of the CNT layer without a coating: heat stability, UV stability, electromagnetic radiation stability, humidity stability, chemical stability, haze, diffuse light transmittance, mechanical bonding to a substrate, electrical contact with a substrate, work function control, type of charge carrier, mechanical strength, abrasion resistance, sheet resistance, broad spectrum transparency, specific wavelength transparency, refractive index matching. Metal (M) oxides (O) are of the form MₓO_{y}, where x is preferably 1-5, y is preferably 1-5, and M is preferably Al, Zn, Ti, Si (preferably in combination with others), Sn, Bi, In, Pb, Cr, Nb, Ta, Nd, V, Sc, Mn, Mo, Co, Ni, W, Ge, Ga, Zr, Cu, Fe, Mg, Ba, Lanthanides, etc. Combinations of metal oxides are advantageous and also preferred for some applications. CNT-metal oxide coatings maintain surface conductivity, have improved abrasion resistance, and reduce or eliminate UV and thermally induced changes in sheet resistance. Oxides for embodiments of this invention are preferably amorphous.

Amorphous oxides are formed by sol-gel processes in a polycondensation reaction under kinetically controlled reaction conditions. In this invention, it is preferred that the metal oxide coatings obtained be amorphous, non-crystalline, and/or lack long-range order. The choice of reagents, additives, and reaction, drying, and sintering conditions allows for the control of the degree of crystallinity or lack of crystallinity. In processing the sol, the amount of acid added to the sol can affect the crystallinity of the resulting coating. Mild hydrolysis of metal oxide precursors avoids crystallization. Over-hydrolyzing the sol tends to produce more crystalline coatings. The amount of acid is controlled in order to avoid crystallization, resulting in an amorphous film. Base catalyzed sols are preferably not used because of their tendency to rapidly hydrolyze sols and to cause crystallization of coatings during drying in some metal oxide systems. Optionally, chelating agents are added to stabilize the sol and avoid crystalline products.

Once deposited, the costing contains a mixture of metal oxide and metal alkoxide, where a portion of the metals have formed M-O-M (metal-oxygen-metal) networks. After deposition and drying of a metal oxide coating under ambient conditions, the coating undergoes weight loss and shrinkage through loss of organics, polymerization, and structural relaxation. For example, as the organic alkoxides and solvent departs from the coating, the composition transitions to a greater percentage of metal oxide. Polymerization also leads to increasing the relative content of metal oxide, since M-OH groups are converted to M-O-M linkages, with water as reaction product. Both of these processes are incomplete at room temperature and are typically incomplete at less than several hundred degrees C., and thus coatings processed under the described conditions are not stoichiometric metal oxides (e.g. Al₂O₃, TiO₂, etc.) but metal oxides with some OH and organic groups. Nonetheless, we refer to these compositions as metal oxides.

Metal oxide coatings remain amorphous when kept at temperatures well below the Hüttig temperature (˜0.2 to 0.3 of the melting temperature in K.). Tammann temperature is the temperature necessary for lattice (bulk) recrystallization for metal oxides. The Hüttig temperature is the temperature necessary for surface recrystallization for metal oxides. Tammann≈0.52 TF, and THuttig≈0.26 TF, with TF the absolute melting temperature of the metal oxide. The melting temperature of Aluminum oxide, Titanium dioxide, and Zinc oxide are 2,054° C., 1,800° C., and 1,975° C., respectively, and the Hüttig temperatures are 534° C., 468° C., and 514° C., respectively. It has been shown that sol-gel derived TiO₂ coatings heated to temperatures above 400 degrees C. crystallize, while mixed TiO₂-Al₂O₃ systems exhibit crystallization at 773 degrees C. (Kondo et al., 2005). ZnO films have been found to crystallize at ˜420 degrees C. (Yoon and Kim, 2007). By maintaining processing temperatures below 400 degrees C., preferably below 300 degrees C., and more preferably below 200 degrees C., crystallization of the metal oxide coatings is avoided, and amorphous coatings result. (Frenzer G, Maier W F, “Amorphous porous mixed oxides: Sol-gel ways to a highly versatile class of materials and catalysts,” Annual Review of Materials Research 36: 281-331 2006; Kondo J N, Yamashita T, Nakajima K, et al., “Preparation and crystallization characteristics of mesoporous TiO2 and mixed oxides,” Journal of Materials Chemistry 15 (20): 2035-2040 2005; Yoon S H, Kim D J, “Effect of substrate on the preferred orientation of ZnO films by chemical solution deposition,” Journal of Crystal Growth 303 (2): 568-573 May 15, 2007).

Fabrication of a coating by the methods of the invention comprises preparation of metal alkoxide precursor solutions in alcohol or other organic solvents. Any solvent that is volatile and can dissolve metal alkoxide is suitable as a solvent. Isopropanol, isobutanol, and 4-methoxy-2-propanol are preferred solvents for preferred metal alkoxides. Alcohols are suitable for metal alkoxide solvents, such as methanol, propanol, ethanol, and butanol. To modify the process of hydrolysis, the alcohol is mixed with, preferably, about less than 25% organic solvent selected from, for example, hydrocarbons, ketones, and acetic esters. Preferably, a small amount of water is added to the solvent. Preferably, a small amount of acid, such HCl or an acetic acid, is added to stabilize the solution by partial hydrolysis and/or creation of M-O-M networks. The concentration of metal alkoxide is preferably between about 1% by weight and about 25% by weight, and more preferably about 3% to 15% by weight, and more preferably about 10% by weight. Higher weight concentrations are beneficial for more rapid and thicker coatings.

More preferred metal alkoxides are titanium butoxide, aluminum butoxide (sec), and zinc methoxy-ethoxide. Other preferred metal alkoxides have the form M(R)ₓ, where M is selected from the group consisting of Al, Zn, Ti, Sn, In, Pb, Cr, Nb, Bi, Ta, Nd, V, Sc, Mn, Mo, Co, Ni, W, Ge, Ga, Zr, Cu, Fe, Mg, Ba, and Lanthanides, and combinations thereof, R is selected from the group consisting of ethoxide, propoxide, isopropoxide, butoxide, etc., and combinations thereof, and x is the valence of the metal. Those skilled in the art will also know that combinations of these compounds are readily formed or layered as needed and may also include silicates to add hardness. Preferably, non-silicate metal alkoxides are used for embodiments of this invention. Silicon-based metal oxides are typically used to make thick films, and typically, carbon nanotubes are blended into them. For embodiments of the present invention, non-silicate metal alkoxides are used to make thin films which are flexible and do not easily break. The metal alkoxides used in the present invention are also not baked to the point of crystallization, thus resulting in amorphous metal oxide composites.

Without wishing to be bound by theory, binders comprising metal oxides according to certain embodiments of this invention are insulating or dielectric. In other words, said metal oxides preferably insulate the underlying electrically conductive network of substantially disentangled (having no or few clumps or birds nest structures), substantially aligned (e.g. the majority of tubes in a field of view are aligned), high aspect ratio (e.g. greater than 1-5, 1-10, 1-100, 1-500, 1-1,000, 1-10,000 or more) carbon nanotubes which preferably have an outer diameter of less than 3.5 nm, are preferably double-walled, and are more preferably single-walled. Metal oxides of preferable embodiments are not crystalline, but amorphous and not conductive. Metal oxides that have been allowed to crystallize and metal oxides that have been doped and are conductive cannot be reversed from their end product mineral state to a non-crystalline, amorphous state in order to function according to certain embodiments of this invention.

The multi-step process according to certain embodiments of this invention, that is forming a CNT network layer on a substrate first, then applying an amorphous metal oxide comprising binder formed through a sol-gel procedure preferably results in a composite with at least two differing conductivities: a CNT network resistance (which is preferably low in order for the CNT layer to be conductive) and a metal oxide binder resistance (which is preferably high to impart insulative and protective properties onto the CNT layer). For example, a Ti—Al—Zn binder preferably has a sheet resistance of approximately 10⁷ Ω/□. The binder resistance is preferably between 10⁵ and 10²² Ω/□, more preferably greater than 10⁶ Ω/□, more preferably greater than 10⁷ Ω/□, even more preferably greater than 10⁸ Ω/□. The CNT network resistance is preferably less than 10⁶ Ω/□, more preferably less than 10⁵ Ω/□, more preferably less than 10⁴ Ω/□, more preferably less than 10³ Ω/□, more preferably less than less than 10² Ω/□, and more preferably less than less than 10¹ Ω/□. The metal oxide binder resistance to CNT network resistance ratio is preferably between 10 and 10²², more preferably between 10⁵ and 10²², and more preferably greater than 10⁷.

In one embodiment, the metal alkoxide solution is combined with refractory particles. The refractory particles are co-deposited onto the CNT network and improve abrasion resistance or surface finish. In other embodiments, the metal alkoxide solution is combined with polymers, such as polyethylene, polypropylene, polyvinyl chloride, styrenes, polyurethane, polyimide, polycarbonate, polyethylene terephthalate, cellulose, gelatine, chitin, polypeptides, polysaccharides, polynucleotides, conducting polymers, fully or partially halogenated polymers, acidic polymers, ionic polymers, and combinations and mixtures thereof. The polymers and metal alkoxides are co-deposited onto the CNT film to improve durability, flexibility, abrasion resistance, bonding to the substrate, refractive index, coefficient of thermal expansion matching, and combinations thereof. The ratio of polymer to metal alkoxide is preferably between 1:10 and 10:1 by weight, but may be from 2:8 to 8:2 by weight, from 4:7 to 7:4 by weight, or from 3:6 to 6:3 by weight or relative equal or 5:5 by weight.

Metal oxide coatings act as anti-reflective coatings. In a preferred embodiment, carbon nanotube-metal oxide composites are multi-functional composites that are conductive, transparent and act as an anti-reflective coating. Anti-reflective or antireflection (AR) coatings are a type of optical coating applied to transparent substrates or optical devices to reduce reflection. This coating improves the efficiency of the system by increasing transmitted light. In complex optical systems, the reduction in reflections also improves the contrast of the image by elimination of stray light. In other applications, the primary benefit is the elimination of the reflection itself, such as a coating on eyeglass lenses that makes the eyes of the wearer more visible, or a coating to reduce the glint from a sniper's scope. A composite comprising nanotubes and AR coatings is particularly advantageous for high performance optics where high light transmission and anti-static coatings to reduce dust accumulation are needed. When ITO (indium tin oxide) is coated with an AR coating, such as MgF, of Al2O3, the resulting multilayer structure does not have surface conductivity. Metal oxides have tunable refractive index based on the composition of the metal and the density of the metal oxide. A less dense coating has a refractive index closer to air, whereas a more dense coating has a refractive index closer the bulk metal oxide.

Often, coatings are composed of transparent thin film structures, with alternating layers of contrasting refractive index. In this instance, nanotube layers are embedded in one or more of the alternating layers. Layer thicknesses are chosen to produce destructive interference in the beams reflected from the interfaces, and constructive interference in the corresponding transmitted beams. This makes the structure's performance change with wavelength and incident angle, so that color effects often appear at oblique angles. A wavelength range must be specified when designing or ordering such coatings, but good performance is achieved for a relatively wide range of frequencies: usually a choice of IR, visible, or UV is offered. In a preferred embodiment the multilayer AR coating is conductive and transparent in the UV, visible, or IR. A further advantage is that the metal oxide-AR composite maintains surface conductivity. When ITO is coated with a multilayer AR coating, the resulting structure does not have surface conductivity.

The simplest interference AR coating consists of a single quarter-wave layer of transparent material whose refractive index is preferably the square root of the substrate's refractive index. This theoretically gives zero reflectance at the center wavelength and decreased reflectance for wavelengths in a broad band around the center.

By using alternating layers of a low-index material like metal oxides and a higher-index material, it is possible to obtain reflectivities as low as 0.1% at a single wavelength. Coatings that give very low reflectivity over a broad band are also made according to embodiments of this invention, although these are complex and relatively expensive. Coatings according to embodiments of this invention can also be preferably made with special characteristics, such as near-zero reflectance at multiple wavelengths, or optimum performance at angles of incidence other than zero degrees.

Metal alkoxide solutions are deposited onto CNT coated substrates via conventional wet-coating methods according to certain embodiments of this invention. These methods include, but are not limited to spin coating, dip coating, kiss coating, knife casting, gravure, or slot die. Evaporation of the carrier solvents result in uniform, pin-hole and defect free hydrated metal oxide coatings. Preferably, CNT films on glass or plastic substrates are dip coated in metal alkoxide solution and withdrawn from the solution at a rate between 0.05 and 1,200 inches per minute, and more preferably between 1 and 100 inches per minute. In one preferred embodiment, several coatings of a single type or composition of metal oxide are applied. In this embodiment, the CNT film is preferably coated with metal alkoxide solution, titanium butoxide for example, and is allowed to dry in air for about 5 seconds to several hours, depending on the solvent and desired drying conditions. Then the sample is preferably re-coated with the same solution, resulting in multilayer coatings. In this embodiment, the number of additional coatings can be no additional coatings to about twenty additional coatings. In another preferred embodiment, the CNT film is coated with one metal alkoxide solution, titanium butoxide for example, and then is allowed to dry, and then is coated with a different metal alkoxide solution, zinc methoxyethoxide for example. A sample can be coated with several different types of metal alkoxide solutions using this embodiment. This embodiment can be preferably combined with the previously described embodiment of repeatedly dipping a CNT film in the same type of metal alkoxide solution to make multilayer coatings. In another preferred embodiment, a mixture of metal alkoxides in solution is preferably employed as a film former, for example titanium butoxide and aluminum butoxide (sec). This embodiment can preferably be combined with the previous two embodiments, so that several layers of mixed and single metal oxides are deposited onto a CNT film.

The dehydration process occurs preferably between about 100 deg C. and about 300 deg C., and more preferably between about 85 deg C. and about 180 deg C., and more preferably between about 100 deg C. and 150 deg C. The time for dehydration is preferably between about twenty minutes and about forty eight hours, and more preferably between about one hour and about six hours. The preferred atmosphere for baking or dehydration is air.

After dehydration, the CNT-metal oxide composite preferably retains surface conductivity. While not bound to theory, it is thought that the metal oxide coatings fill the pores in the CNT network and bind the nanotubes together. The films are preferably not substantially thicker than the nanotube network, as evinced by the surface conductivity being maintained after multiple coatings. It is also possible to coat the nanotube network with a very thin (e.g. <10 nm, <5 nm, <2 nm, <1 nm) coating of the metal oxide such that the network remains porous and additional metal oxide or other matrix material such as polymers can be added sequentially.

The preferred thickness of the CNT-metal oxide composite is less than 1 micron. A further preferred thickness of the CNT-metal oxide composite is less than about 500 nm. More preferably, the thickness of the CNT-metal oxide composite is between about 150 nm and 250 nm, more preferably between 25 nm and 150 nm, more preferably between 25 nm and 100 nm, and more preferably about 25 nm or less.

After dehydration of the CNT-metal oxide composite, the sequential addition of polymer binders, coatings, or films is beneficial to selectively improve specific properties of the CNT-metal oxide composite, such as: conductivity; haze; transparency; reflectivity; clarity; color neutrality; index of refraction; changes in sheet resistance due to humidity, UV, or heat; abrasion resistance; flexibility; adhesion; chemical resistance; and combinations thereof. Preferably, two or more, three or more, or four or more materials (such as polymer binders, coatings, films, metal-oxide layers) according to embodiments of this invention are sequentially layered onto the carbon nanotube network without changing the thickness of the film. Without wishing to be bound by theory, the preservation of the composite sequence is possible because of the multi-step layer process according to embodiments of this invention, in contrast to the blending of CNT with polymers or metal oxides according to methods used by many skilled in the art.

The range of polymers that can be added sequentially is substantially broad and includes, but is not limited to all classes or polymers listed herein including conjugated polymers, ceramic polymers, ceramic hybrid polymers, polyethylene, polypropylene, polyvinyl chloride, styrenes, polyurethane, polyimide, polycarbonate, polyethylene terephthalate, cellulose, gelatine, chitin, polypeptides, polysaccharides, polynucleotides, and mixtures thereof. In one embodiment, the plastics may be thermosets, thermoplastics, elastomers, conducting polymers, fully or partially halogenated polymers, acidic polymers, ionic polymers and combinations thereof. Other additives may be included in the polymer or added sequentially to improve the functional properties of the CNT layer or coating. In a preferred embodiment, the added polymer coating is polystyrene sulfonic acid. In another preferred embodiment, the added polymer is PTFE (Teflon). In another preferred embodiment, the added polymer is Nafion (Nafion comprises a copolymer of tetrafluoroethylene and perfluorinated monomers containing a sulfonic acid groups). In another preferred embodiment, the added polymer is PVDF. In a more preferred embodiment, the CNT-metal oxide-polymer composite retains surface conductivity.

In a preferred embodiment, the addition of a coating or coatings comprising one or more metal oxides to a CNT film lowers the sheet resistance of the CNT layer. In a more preferred embodiment, the addition of a coating or coatings comprising one or more metal oxides to a CNT film lowers the sheet resistance of the CNT layer between about 30% and 15% (e.g. 29%, 28%, 27%, 26%, 25%, 24%, 23%, 22%, 21%, 20%, 19%, 18%, 17%, 16%). In another preferred embodiment, the addition of a coating or coatings comprising one or more metal oxides to a CNT film lowers the sheet resistance of the CNT layer between about 15% and 5% (e.g. 14%, 13%, 12%, 11%, 10%, 9%, 8%, 7%, 6%). In another embodiment, the addition of a coating or coatings comprising one or more metal oxides to a CNT film does not change the sheet resistance of the CNT layer. In another embodiment, the addition of a coating or coatings comprising one or more metal oxides to a CNT film increases the sheet resistance of the CNT layer of 20% or less (e.g. 15% or less, 10% or less, 5% or less, 1% or less). In another preferred embodiment, the addition of a coating or coatings comprising one or more metal oxides to a CNT film followed by the addition of a coating or coating comprising polymers lowers the sheet resistance of the CNT layer further: preferably the sheet resistance of the CNT layer is lowered by between 10% and 20%, more preferably between 20% and 30%, and more preferably by more than 30% (e.g. 35% or more, 40% or more 50% or more) by the addition of coating(s) comprising metal oxide(s) and additional coating(s) comprising polymers. In another preferred embodiment, the addition of a coating or coatings comprising one or more metal oxides to a CNT film followed by the addition of a coating or coatings comprising polymers does not change the sheet resistance of the CNT layer.

In a preferred embodiment, the addition of a coating or coatings comprising one or more metal oxides to a CNT film causes the sheet resistance of the composite to remain stable over an extended period of time. Also preferred are 2 to 3 coatings. In a further preferred embodiment, the addition of a coating or coatings comprising one or more metal oxides to a CNT film causes the sheet resistance of the composite to remain stable at room temperature, room lighting, and room humidity over an extended period of time. In a further preferred embodiment, the addition of a coating or coatings comprising one or more metal oxides to a CNT film causes the sheet resistance of the composite to remain stable at elevated temperature, outdoor lighting, and high humidity over an extended period of time. In a further preferred embodiment, the addition of a coating or coatings comprising one or more metal oxides to a CNT film causes the sheet resistance of the composite to increase less than 5% at room temperature, room lighting, and room humidity over a period of about 100,000 hours or more. In a further preferred embodiment, the addition of a coating or coatings comprising one or more metal oxides to a CNT film causes the sheet resistance of the composite to increase less than 10% at elevated temperature, outdoor lighting, and high humidity over a period of about 100,000 hours or more. In a further preferred embodiment, the addition of a coating or coatings comprising one or more metal oxides to a CNT film causes the sheet resistance of the composite to increase less than 30% at 100 deg C. for a period of about 500 hours or more. In a further preferred embodiment, the addition of a coating or coatings comprising one or more metal oxides to a CNT film causes the sheet resistance of the composite to increase less than 30% under UV light for about 200 hours or more. In a further preferred embodiment, the addition of a coating or coatings comprising one or more metal oxides to a CNT film causes the sheet resistance of the composite to increase less than 10% at 100 deg C. for about 500 hours or more. In a further preferred embodiment, the addition of a coating or coatings comprising one or more metal oxides to a CNT film causes the sheet resistance of the composite to increase less than 10% at under UV exposure for about 260 hours or more. In another preferred embodiment, the addition of a coating or coatings comprising one or more metal oxides to a CNT film causes the sheet resistance of the composite to increase less than 5% at 100 deg C. and under UV exposure for about 1,000 hours or more.

In a preferred embodiment, the addition of a polymer coating or coatings to a CNT-metal oxide composite forms a CNT-metal oxide-polymer composite with a total light transmittance about equal to the CNT film without any added films. In another preferred embodiment, the addition of a polymer coating or coatings to a CNT-metal oxide composite forms a composite with a total light transmittance up to about 5% absolute transmittance greater than the CNT film without any added films. In another embodiment, the addition of a polymer coating or coatings to a CNT-metal oxide composite forms a composite with a total light transmittance up to about 5% absolute transmittance less than the CNT film without any added films.

In one preferred embodiment, specific metal alkoxide precursors are used in specific stoichiometric ratios. In this embodiment, the metal alkoxides decompose into metal oxides of a specific composition that is conductive and transparent. For example, In₅O(OR)₁₃, where R is isopropyl, and Sn(OR)ₓ, where x is 4 or 2 and isopropyl, is combined in isopropanol and is used to coat CNT films as described above. After coating, the hydrated metal oxide coating is baked, resulting in a metal oxide film. For example, the metal oxide results is a mixture of indium(III) oxide (In₂O₃) and tin(IV) oxide (SnO₂), of about 90% In₂O₃ and about 10% SnO₂ by weight. The resulting CNT-conductive metal oxide composite has all of the advantages of the CNT-metal oxide films described above. In addition, it is preferred that both the metal oxide and the CNT contribute to the conductivity of the film. It is further preferred that the CNT increase the ductility of the metal oxide film. It is also preferred that the CNTs bridge cracks in the metal oxide that may develop during use of the composite and provide conductive pathways to maintain film optoelectronic performance.

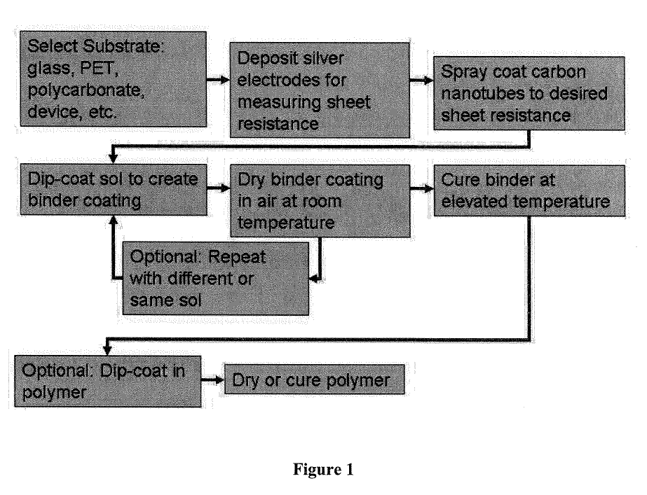

Samples of transparent conductive coatings were prepared using a set of steps that result in a carbon nanotube-metal oxide coating ready for use in a device or for environmental testing, these steps are depicted in FIG. 1. A substrate is selected that meets the requirements of the desired application. Typically, electrodes made of silver ink, paste, or epoxies are applied to the substrate to monitor sheet resistance of the coating during testing. If the silver paint contains a soluble polymer, the electrodes are optionally baked at between 250 degrees and 500 degrees to consolidate the silver.

Carbon nanotubes are deposited from ink onto the substrate; typically, the ink is spray coated onto the substrate. Samples of coated substrate or free standing films are then dip coated into a metal alkoxide sol. The preparation of the sol is described in the examples. Next, the sample is dried in air. If another layer of binder is desired, the sample can be dipped in the same sol or in a different sol. Dipping in the same sol increases coating thickness and can increase protection. Dipping in different sols increases coating thickness and can provide increased protection greater than a single-composition binder coating. After the binder is dried in air, it is placed in an oven at 120 degrees C. for 2.25 hours to cure the sol gel. For substrates that cannot withstand 120 degrees C., a lower temperature and longer cure time is used.

Heat tests were conducted in air by placing samples at room temperature into an oven at about 80 degrees C. At a set time, samples were removed and cooled to room temperature before measuring sheet resistance and transparency. Resistance (which was measured in Ohms per square) and transparency were measured about 15 minutes after removal from the oven.

UV tests were conducted using a Q-Panel, UVA-340 lamp in air. The distance between the bulb and sample was measured to be 25 cm, and the sample temperature was measured to be 40° C. during testing. At a set time, samples were removed and cooled to room temperature before measuring sheet resistance. Resistance (which was measured in Ohms per square) and transparency were measured about 15 minutes after removal from the UV test.

The following examples illustrate embodiments of the invention, but should not be viewed as limiting the scope of the invention.

### EXAMPLES

Metal Alkoxide Solutions with Suitable Solvents for Each Mono or Multi-Precursor System Were Prepared.

### Example 1

### ZnO Binder

To make a 3.7% weight zinc alkoxide sol, 46.82 grams of 2-Propanol were added into a 250 ml container. Next, 1.7947 grams of Zinc Methoxyethoxide (Gelest) was weighed into the same container. Concentrated Hydrochloric Acid was slowly added to the container until 1.3853 grams were added. A sonication bath is preferably used to dissolve the Zinc Methoxyethoxide. Care should be taken to not overshoot the amount of acid added as this may affect the properties the final coating. The solution should be stored in a tight sealing container to prevent moisture from entering the container and prevent evaporation of the 2-propanol. For larger batches, the ratio of reagents is listed in Table 1: Weights of reagents for producing Zn alkoxide sol of different quantity.

TABLE 1
Weights of reagents for producing Zn alkoxide sol of different quantity

| Compound | Factor | 50 Grams | 100 Grams | 1000 Grams |
|---|---|---|---|---|
| IPA | 0.9364 | 46.8200 | 93.64 | 936.40 |
| Zinc | 0.035895 | 1.7947 | 3.5895 | 35.8948 |
| Methoxyethoxide | | | | |
| HCl | 0.027705 | 1.3853 | 2.7705 | 27.7052 |

Glass slides coated with CNT were dip coated in zinc alkoxide sol made in a similar fashion to the description above, but at 2.2% by weight zinc methoxyethoxide. Samples were dipped twice at a speed of 2.57 inch/min. The samples were then placed in the oven at 120 degrees C. for 2.5 hours. Controls of CNT on glass with no binder were placed in the oven under the same conditions. Samples were heat tested and measured as described above. Sheet resistance of samples was measured after spraying, after curing the binder, at 24, 48, 120, 220, and 472 hours. The data are listed in Table 2: Resistance of samples with Zn oxide binder during heating at 80 deg C. for up to 472 hours:

TABLE 2
Resistance of samples with Zn oxide binder during
heating at 80 deg C. for up to 472 hours

| | | Sprayed | | | | | | |
|---|---|---|---|---|---|---|---|---|
| Binder | Sample | CNT R | R start | R/25 | R/48 | R/120 | R/220 | R/472 |
| Zn | S-5-11 | 348 | 543 | 543 | 577 | 614 | 578 | 588 |
| Zn | S-5-12 | 287 | 465 | 384 | 343 | 327 | 440 | 467 |
| None | control-5-9 | 300 | 392 | 578 | 970 | 2201 | 923 | 2151 |

Samples prepared in the same fashion were subjected to UV testing. The testing procedure is described above. Sheet resistance of samples was measured after spraying, after curing the binder, at 24, 48, and 115 hours. The data are listed in Table 3: Resistance of samples with Zn oxide binder during UV exposure for up to 115 hours

TABLE 3
Resistance of samples with Zn oxide binder during UV exposure for up to 115 hours

| | | Sprayed | | | | | % change | % change |
|---|---|---|---|---|---|---|---|---|
| binder | Sample | CNT R | R start | R/24 | R/48 | R/115 | Test | Sprayed |
| ZnO | S-5-13 | 296 | 446 | 446 | 475 | 512 | 14.8 | 72.9 |
| ZnO | S-5-14 | 288 | 615 | 668 | 784 | 780 | 26.8 | 170.8 |
| none | control-5-8 | 277 | 325 | 472 | 804 | 792 | 143.7 | 186 |

Similar experiments were repeated with titanium alkoxide coating and aluminum alkoxide coating. All oxides suppressed Rs loss under heat. Aluminum oxide coatings showed modest protection. CNT protected with TiO₂, on the other hand, demonstrated 25% increase in Rs while ZnO less than 10% during the test. It is thus apparent that metal oxide coatings minimize heat related degradation of CNT coatings for applications that require elevated temperature stability.

In addition to identifying stabilizing materials against thermal exposures, there is equally relevant need to prevent damages due to UV and visible light. Many materials including polymers degrade under sunlight. This was assessed by exposing CNT materials to simulated sunlight (Q-Panel, UVA-340 lamp) for 115 hours. Unprotected CNT films demonstrated a rapid increase in surface resistance (Rs) in UV light. TiO2 coated CNT did not show the same benefits as Al₂O₃ and ZnO. Carbon nanotube films coated with ZnO and Al₂O₃ demonstrated only modest increase in surface resistance: 25% and 50% respectively.

### Example 2

### TiO₂—ZnO Binder

Glass slides coated with CNT were dip coated in 10.2% Ti butoxide sol (2 dips, at a speed of 3.33 inch/min), dried in air, and then dipped (4 dips, speed 4.07 inch/min) in 2.2% zinc alkoxide sol. The samples were then placed in the oven at 120 degrees C. for 2.5 hours. Controls of CNT on glass with no binder were placed in the oven under the same conditions. Samples were heat tested and measured as described above. Samples were placed in an oven at 80 degrees C. for heat testing. Sheet resistance of samples was measured after spraying, after curing the binder, at 24, 48, 72, 96, 144, and 260 hours. The data are listed in Table 4: Resistance of samples with Ti—Zn oxide binder during heating at 80 deg C. for up to 260 hours, compared to controls (Cont) of uncoated CNT layers:

TABLE 4
Resistance of samples with Ti—Zn oxide binder during heating at 80 deg
C. for up to 260 hours, compared to controls (Cont) of uncoated CNT layers

| | | Sprayed | | | | | | | |
|---|---|---|---|---|---|---|---|---|---|
| Binder | Sample | CNT/R | R start | R/24 | R/48 | R/72 | R/96 | R/144 | R/260 |
| Ti—Zn | sample 2 | 499 | 474 | 497 | 508 | 496 | 491 | 495 | |
| Ti—Zn | S-8-1 | 740 | 551 | 617 | 635 | 628 | 640 | 628 | 638 |
| Ti—Zn | S-8-2 | 542 | 436 | 488 | 512 | 497 | 497 | 486 | 496 |
| none | cont-7-1 | 536 | 631 | 920 | 958 | 979 | 977 | 1018 | 1614 |
| none | cont.7-2 | 648 | 741 | 1053 | 1115 | 1133 | 1139 | 1191 | 1826 |
| none | cont-8-1 | 517 | 569 | 803 | 839 | 852 | 846 | 895 | 1438 |

Samples prepared in the same fashion were subjected to UV testing. The testing procedure is described above. Sheet resistance of samples was measured after spraying, after curing the binder, at 24, 48, 72, and 96 hours. The data are listed in Table 5: Resistance of samples with Ti—Zn oxide binder during UV exposure for up to 96 hours, compared to controls (Cont) of uncoated CNT layers:

TABLE 5
Resistance of samples with Ti—Zn oxide binder during UV exposure
for up to 96 hours, compared to controls (Cont) of uncoated CNT layers

| | | Sprayed | | | | | |
|---|---|---|---|---|---|---|---|
| Binder | Sample | CNT/R | R start | R/24 | R/48 | R/72 | R/96 |
| Ti—Zn | S-8-3 | 441 | 851 | 978 | 1083 | 1187 | 1280 |
| Ti—Zn | S-8-4 | 615 | 1173 | 1325 | 1438 | 1564 | 1663 |
| none | Contr-7-3 | 612 | 830 | 922 | 1055 | 1185 | 1326 |
| none | Cont 7-4 | 788 | 1072 | 1168 | 1314 | 1462 | 1631 |
| none | Cont-8-2 | 567 | 756 | 840 | 952 | 1062 | 1183 |

### Example 3

### Al₂O₃—ZnO Binder

A solution of aluminum alkoxide was used for forming of Al₂O₃ binder. 10 g of aluminum butoxide were weighed out and put in a container. 90 g of absolute IPA were weighed out in the same container. Solution was mixed for 15 minutes for dissolving of alkoxide. The prepared transparent solution was stabilized by adding concentrated Hydrochloric Acid. The acid was added slowly drop-wise. A sonication bath is optionally used to help dissolve any solid deposit. See Table 6: Weights of reagents for producing Al alkoxide sol of different quantity for ratios of different batch sizes:

TABLE 6
Weights of reagents for producing Al alkoxide sol of different quantity

| Compound | Factor | 50 Grams | 100 Grams | 1000 Grams |
|---|---|---|---|---|
| IPA | 0.90 | 45 | 90 | 900 |
| Aluminum | 0.10 | 5 | 10 | 100 |
| Butoxide | | | | |
| HCl | 0.01 | 0.5 | 1 | 10 |

Glass slides coated with CNT were dip coated in 10% Al butoxide sol (3 dips, speed 3.3 inch/min), dried in air, and then dipped in 2.2% zinc alkoxide sol (4 dips, speed 2.57 inch/min). The samples were then placed in the oven at 120 degrees C. for 2.5 hours. Controls of CNT on glass with no binder were placed in the oven under the same conditions. Samples were heat tested and measured as described above. Samples were placed in an oven at 80 degrees C. for heat testing. Sheet resistance of samples was measured after spraying, after curing the binder, at 24, 48, 72, 96, 144, and 260 hours. The data are listed in Table 7: Resistance of samples with Al—Zn oxide binder during heating at 80 deg C. for up to 260 hours, compared to controls (Cont) of uncoated CNT layers:

TABLE 7
Resistance of samples with Al—Zn oxide binder during heating at 80 deg
C. for up to 260 hours, compared to controls (Cont) of uncoated CNT layers

| Binder | Sample | R start | R/24 | R/48 | R/72 | R/96 | R/144 | R/260 |
|---|---|---|---|---|---|---|---|---|
| Al—Zn | S-7-7 | 626 | 639 | 651 | 697 | 683 | 718 | 759 |
| Al—Zn | S-9-10thin | 743 | 720 | 810 | 894 | 940 | 1165 | |
| none | Cont-7-1 | 631 | 920 | 958 | 979 | 977 | 1018 | 1614 |
| none | Cont-7-2 | 741 | 1053 | 1115 | 1133 | 1139 | 1191 | 1826 |
| none | Cont-8-1 | 569 | 803 | 839 | 852 | 846 | 895 | 1438 |
| none | Contr-9-4 | 831 | 1211 | 1358 | 1575 | 1759 | 1898 | |

Samples prepared in the same fashion were subjected to UV testing. The testing procedure is described above. Sheet resistance of samples was measured after spraying, after curing the binder, at 24, 48, 72, 96, 144, and 260, and 304 hours. The data are listed in Table 8: Resistance of samples with Zn oxide binder during UV exposure for up to 304 hours compared to controls (Cont) of uncoated CNT layers:

TABLE 8
Resistance of samples with Zn oxide binder during UV exposure for
up to 304 hours compared to controls (Cont) of uncoated CNT layers

| Binder | Sample | R start | R/24 | R/48 | R72 | R/96 | R/144 | R/260 | R/304 |
|---|---|---|---|---|---|---|---|---|---|
| Al—Zn | S-7-8 | 709 | 660 | 657 | 606 | 619 | 606 | 685 | |
| Al—Zn | S-9-9 | 752 | 742 | 750 | 762 | 745 | 716 | | 716 |
| none | Contr-7-3 | 612 | 830 | 922 | 1055 | 1185 | 1326 | 1839 | |
| none | Cont 7-4 | 788 | 1072 | 1168 | 1314 | 1462 | 1631 | 2226 | |
| none | Cont-8-2 | 567 | 756 | 840 | 952 | 1062 | 1183 | 1603 | |
| none | Contr.-9-1 | 711 | 1061 | 1358 | 1570 | 1713 | 2176 | | 3770 |

### Example 4

### TiO₂—Al₂O₃—ZnO Binder

A sol containing 12.96% Titanium Butoxide and 9.35% Aluminum Butoxide was made, based on weight percentage. All reagents were added directly to the mixing container using a scale to attain weights. 149.43 grams of dry 2-Propanol into a 250 ml container were weighed out. 24.925 grams of Titanium n-Butoxide (Gelest) were weighed out into the 2-Propanol. The sol was gently mixed without agitating or adding air to the mixture. 17.92 grams of Aluminum Butoxide then were added to the mixture, and the sol was gently mixed again. 7.715 grams of concentrated 37% ACS Grade hydrochloric acid (HCl) were added to the solution. Adding too much acid can give poor properties to the final coating. The solution is stored in a tight sealing container to prevent moisture from entering the container and prevent evaporation of the 2-propanol. Shelf life of solutions exceeds 3 months. For larger batches, the ratio of reagents is listed below in Table 9: Weights of reagents for producing Ti—Al alkoxide sol of different quantity:

TABLE 9
Weights of reagents for producing Ti—Al
alkoxide sol of different quantity

| | | 200 | 1000 | 5,000 | 10,000 |
|---|---|---|---|---|---|
| Compound | Factor | Grams | grams | Grams | Grams |
| IPA | 0.747181 | 149.4362 | 747.181 | 3735.905 | 7471.81 |
| Titanium | 0.124629 | 24.9258 | 124.6291 | 623.15 | 1246.291 |
| Butoxide | | | | | |
| Aluminum | 0.08961 | 17.9228 | 89.6142 | 448.07 | 896.1424 |
| Butoxide | | | | | |
| HCl | 0.038576 | 7.71513 | 38.5767 | 192.88 | 385.76 |

Binder containing TiO₂—Al₂O₃—ZnO was created by dipping CNT coated glass slides first in a sol of Al—Ti butoxide similar that described above, though the total weight concentration was 10%, then dipped in a sol of 2.2% zinc methoxyethoxide. The method to create zinc alkoxide sol is described in Example 1.

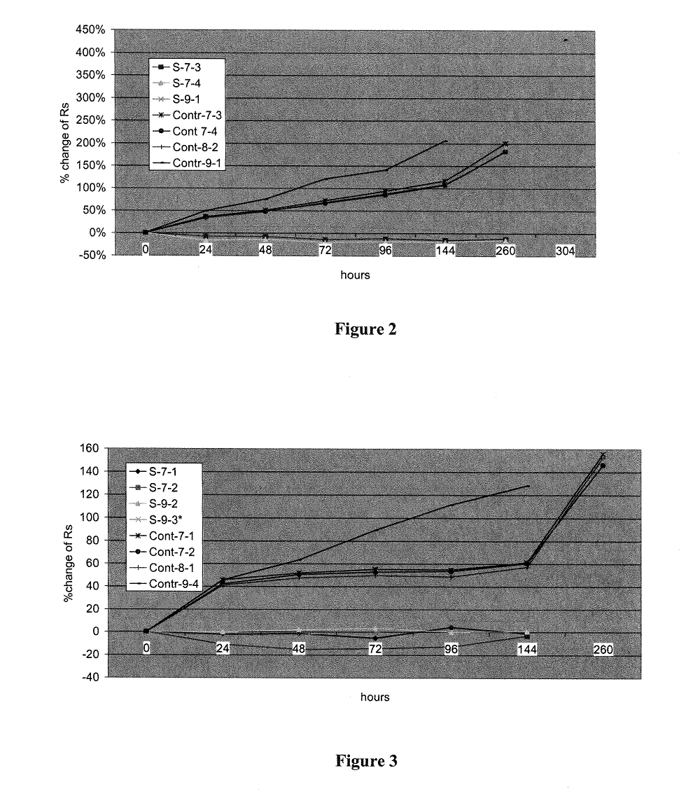

Glass slides coated with CNT were dip coated in 10% based on sum of Ti—Al butoxides sol (3 dips, speed 3.33 inch/min), dried in air, and then dipped in 2.2% zinc alkoxide sol (4 dips, speed 2.57 inch/min). The samples were then placed in the oven at 120 degrees C. for 2.5 hours. Controls of CNT on glass with no binder were placed in the oven under the same conditions. Samples were heat tested and measured as described above. Sheet resistance of samples was measured after spraying, after curing the binder, at 24, 48, 72, 96, 144, and 260 hours. The data are listed in Table 10 and depicted in FIG. 2:

TABLE 10
Resistance of samples with Ti—Al—Zn oxide binder during heating at 80 deg
C. for up to 260 hours, compared to controls (Cont) of uncoated CNT layers

| | | Sprayed | | | | | | | |
|---|---|---|---|---|---|---|---|---|---|
| Binder | Sample | CNT/R | R start | R/24 | R/48 | R/72 | R/96 | R/144 | R/260 |
| Ti—Al—Zn | S-7-1 | 694 | 775 | 757 | 764 | 734 | 808 | 765 | electrode |
| | | | | | | | | | failure |
| Ti—Al—Zn | S-7-2 | 566 | 290 | 258 | 246 | 248 | 253 | 280 | electrode |
| | | | | | | | | | failure |
| Ti—Al—Zn | S-9-2 | 558 | 505 | 504 | 515 | 522 | 505 | 508 | 549 |
| Thin | S-9-3 | 568 | 615 | 587 | 600 | 612 | 679 | 676 | 818 |
| Ti—Al—Zn | | | | | | | | | |
| none | Cont-7-1 | 556 | 631 | 920 | 958 | 979 | 977 | 1018 | 1614 |
| none | Cont-7-2 | 648 | 741 | 1053 | 1115 | 1133 | 1139 | 1191 | 1826 |
| none | Cont-8-1 | 517 | 569 | 803 | 839 | 852 | 846 | 895 | 1438 |
| none | Contr-9-4 | 711 | 831 | 1211 | 1358 | 1575 | 1759 | 1898 | |

Samples prepared in the same fashion were subjected to UV testing. The testing procedure is described above. Sheet resistance of samples was measured after spraying, after curing the binder, at 24, 48, 72, 96, 144, 260, and 304 hours. The data are listed in Table 11 and depicted in FIG. 3:

TABLE 11
Resistance of samples with Ti—Al—Zn oxide binder during UV exposure
for up to 304 hours compared to controls (Cont) of uncoated CNT layers

| | | Sprayed | | | | | | | | |
|---|---|---|---|---|---|---|---|---|---|---|
| Binder | | CNT/R | R/start | R/24 | R/48 | R/72 | R/96 | R/144 | R/260 | R/304 |
| Ti—Al—Zn | S-7-3 | 544 | 598 | 553 | 552 | 514 | 528 | 508 | 525 | Stopped |
| | | | | | | | | | | test |
| Ti—Al—Zn | S-7-4 | 571 | 626 | 524 | 541 | 498 | 514 | 504 | 533 | Stopped |
| | | | | | | | | | | test |
| Ti—Al—Zn | S-9-1 | 586 | 504 | 580 | 576 | 576 | 562 | 533 | | 580 |
| Ti—Al—Zn | Contr-7-3 | 532 | 612 | 830 | 922 | 1055 | 1185 | 1326 | 1839 | Stopped |
| | | | | | | | | | | test |
| none | Cont 7-4 | 664 | 788 | 1072 | 1168 | 1314 | 1462 | 1631 | 2226 | Stopped |
| | | | | | | | | | | test |
| none | Cont-8-2 | 528 | 567 | 756 | 840 | 952 | 1062 | 1183 | 1603 | Stopped |
| | | | | | | | | | | test |
| none | Contr-9-1 | 672 | 711 | 1061 | 1248 | 1570 | 1713 | 2176 | | 3770 |

### Example 5

### TiO₂—Al₂O₃—ZnO-PVDF Binder

Samples were prepared as described in example 4. These samples were dip coated in a solution of Polyvinylidene fluoride (PVDF, 5% conc. by weight, 1 dip, 3.33 inch/min) in methyl isobutyl ketone. These samples were dried in air, and then placed in an oven for a half an hour at 80 degrees C. Samples were placed in an oven at 80 degrees C. for heat testing. Sheet resistance of samples was measured after spraying, after curing the binder, at 24, 144, 264, 306, 400 hours. The data are listed in Table 12:

TABLE 12
Resistance of samples with Ti—Al—Zn oxide-PVDF binder during heat exposure
at 80 deg C. for up to 400 hours, compared to controls (Cont) of uncoated CNT layers

| Binder | Sample | Rstart | R/24 | R/144 | R/264 | R/306 | R/400 |
|---|---|---|---|---|---|---|---|
| Al—Ti—Zn- | S-19-1 | 610 | 618 | 650 | 622 | 621 | 719 |
| PVDF | | | | | | | |
| Al—Ti—Zn- | S-19-2 | 677 | 689 | 721 | 681 | 716 | 820 |
| PVDF | | | | | | | |
| Al—Ti—Zn- | S-19-3 | 507 | 519 | 544 | 513 | 545 | 615 |
| PVDF | | | | | | | |
| none | Cont-19-1 | 488 | 628 | 680 | 1028 | 1424 | 2131 |
| none | Cont-19-2 | 438 | 557 | 619 | 1037 | 1211 | 1718 |

Samples prepared in the same fashion were subjected to UV testing. The testing procedure is described above. Sheet resistance of samples was measured after spraying, after curing the binder, at 24, 144, 264, 306, and 400 hours. The data are listed in Table 13:

TABLE 13
Resistance of samples with Ti—Al—Zn oxide-PVDF binder during UV exposure
for up to 400 hours, compared to controls (Cont) of uncoated CNT layers

| Binder | Sample | Rstart | R/24 | R/144 | R/264 | R/306 | R/400 |
|---|---|---|---|---|---|---|---|
| Al—Ti—Zn- | S-20-1 | 572 | 650 | 682 | 648 | 644 | 648 |
| PVDF | | | | | | | |
| Al—Ti—Zn- | S-20-2 | 644 | 714 | 697 | 688 | 701 | 718 |
| PVDF | | | | | | | |
| Al—Ti—Zn- | S-20-3 | 427 | 482 | 498 | 489 | 486 | 514 |
| PVDF | | | | | | | |
| Al—Ti—Zn- | S-18-8 | 660 | 660 | 713 | 720 | 743 | 759 |
| PVDF | | | | | | | |
| none | Cont-20-1 | 426 | 525 | 870 | 1112 | 1496 | 1885 |
| none | Cont-20-2 | 446 | 579 | 923 | 1159 | 1519 | 1869 |

### Example 6

### Abrasion Resistance of Binder-CNT coatings

Samples were prepared in a similar fashion to that described above. Glass slides coated with CNT were dip coated in Ti butoxide sol and dried in air. The samples were then placed in the oven at 120 degrees C. for 2 hours to cure the binder. Controls of CNT on glass with no binder were placed in the oven under the same conditions. Both samples exhibited surface conductivity, as measured by a four point probe. These samples were subjected to an abrasion test. The sample surface is abraded by using a weight wrapped with cotton cloth for 60 cycles. Before and after the abrasion test, Rs value is tested and compared. A weight of 100 g is used for a sample of 1×1 inches in size. Minimum change means high abrasion resistance. The data are listed in Table 14.

TABLE 14
Abrasion resistance of nanotube conductive
films with Ti dioxide binder.

| Number of | TiO2-CNT | TiO2-CNT | | CNT |
|---|---|---|---|---|
| cycles | Rs | % change | CNT Rs | % change |
| 1 | 380 | 0 | 539 | 0 |
| 3 | 432 | 8.9 | 964 | 78.8 |
| 5 | 442 | 16.3 | 2390 | 343 |
| 7 | 449 | 18.2 | 8700 | 1514 |
| 10 | 461 | 21.3 | 29400 | 5355 |
| 20 | 492 | 29.5 | 360000 | 66690 |
| 30 | 522 | 37.4 | 1.50E+06 | 278193 |
| 60 | 651 | 71.3 | ∞ | ∞ |

### Example 7

### Surface Conductivitv

For many applications, it is a requirement for a transparent conductive film to have surface conductivity. For example, resistive touch screens function by two transparent conductive layers contacting each other to form a conductive pathway. Samples were prepared in a similar fashion to that described in Example 5. Rather than coating the samples with a polymer consisting of PVDF, the samples were coated with a polymer known as Nafion, a perfluorinated sulfonic acid polymer soluble in alcohol. Samples were dipped in 5% Nafion, dried in air, and heated at 100 degrees C. for 30 minutes. These samples underwent heat testing for 408 hours under UV exposure and heat testing. Conductivity of CNT films and CNT-metal oxide films was measured using two techniques after heat testing. The first technique uses silver electrodes underneath the CNT layer. The silver electrodes are in direct contact with the CNT layer, since the CNT was deposited onto the substrate with silver electrodes. The second method uses a Mitsubishi Chemical Loresta GP MCP-T600 meter with an ESP probe. The probe has four evenly spaced pins that are placed on the surface of the film to measure the surface conductivity of the film. See Table 15.

TABLE 15
Conductivity of CNT-Ti—Al—Zn oxide-Nafion (labeled as Al—TiZn)
and CNT without binder (labeled Contr) after UV testing
UV-test

| | | R start | R/408 | Surface |
|---|---|---|---|---|
| Al—Ti—Zn | S-15-1 | 480 | 605 | 460 |
| Al—Ti—Zn | S-15-2 | 379 | 459 | 403 |
| Al—T-—Zn | S-17-1 | 601 | 701 | 670 |
| Al—Ti•Zn | S-17-3 | 639 | 762 | 802 |
| Al—Ti—Zn | S-18-1 | 229 | 300 | 230 |
| Al—Ti—Zn | S-18-2 | 221 | 275 | 228 |
| Al—Ti—Zn | S-18-6 | 247 | 314 | 167 |
| Cont | Cont-15-1 | 510 | 2575 | 2390 |
| Contr | Cont -15-2 | 413 | 1902 | 1580 |
| Contr | Cont-17-1 | 898 | 3310 | 2731 |
| Contr | Cont-17-2 | 760 | 3300 | 2991 |
| Contr | Contr-18-2 | 774 | 3840 | 3075 |
| Al—Ti—Zn | S-17-6 | 669 | 701 | 694 |
| without Nf | | | | |

### Example 8

### Binder Coating Thickness

Samples were dip coated onto glass substrates in a sol containing titanium and aluminum butoxide, in a zinc alkoxide sol, and in Nafion similar to the method described in Examples 1, 4, and 9. Al—Ti oxide layers were cured at 120 degrees C. for 2 hours. Al—Ti—Zn oxide layers were cured at 120 degrees C. for 2 hours, followed by depositing Nafion and heating for 30 minutes at 100 degrees. The thickness of the coatings was measured at a step edge using a Zygo optical profilometer. Thicknesses are listed in Table 16:

TABLE 16
Thickness of binders, based on profilometry.
Step height by Zygo: thickness of dip coating
Step height of coating in nanometers:

| | Al—Ti | Al—Ti—Zn | Al—Ti—Zn Nafion |
|---|---|---|---|
| | 99 | 55 | 124 |
| | 109 | 73 | 128 |
| | 106 | 75 | 131 |
| | 99 | | 169 |
| | 95 | | 168 |
| | 116 | | 68 |
| Average | 104 | 67.66667 | 131.3333 |
| std | 7.797435 | 11.01514 | 36.98468 |

### Example 9

### Forming CNT layer

To form a layer of CNT, first SWNT containing soot is purified by process steps including acid reflux, water rinsing, centrifuge and micro filtration. Then, the purified SWNTs are mixed into a 3:1 solution of isopropyl alcohol (IPA) (or other alcohols) and water to form a carbon nanotube coating solution. (The soot, containing approximately 50-60% carbon nanotubes, purified by refluxing in 3M nitric acid solution for 18 hours at 145±15° C., and then washed, centrifuged and filtered). The purified mixture produces an ink solution containing greater than 99% single walled carbon nanotubes at a concentration of roughly 0.059 g/L. A coating of CNT can be formed by simply spray coating, or any other method of solution deposition method of this ink onto a surface, membrane or other substrate. Ether free standing or substrate supported layer of CNT can be fabricated. It is then typically dried to obtain a layer of CNT that can be infiltrated with sol gel or polymeric solutions, although infiltration may also be conducted using wet layer through solvent exchange.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. The term comprising as used throughout this application includes the more limiting terms and phrases “consisting essentially of” and “consisting.” It is intended that the specification and examples be considered exemplary only with the true scope and spirit of the invention indicated by the following claims.

1. A composite comprising an electrical network of carbon nanotubes and a network of amorphous metal oxide, as an insular, wherein the composite is electrically stable.

2. The composite of claim 1, wherein surface resistance of the composite undergoes a less than 25% change upon exposure to temperatures of 80° C. or greater, electromagnetic radiation, UV radiation, a relative humidity of 15% or greater, physical stress, chemical stress, mechanical stress.

3. The composite of claim 2, wherein the surface resistance undergoes a less than 20% change, less than 15% change, less than 10% change, or less than 5% change.

4. The composite of claim 2, wherein the surface resistance undergoes no detectable or significant change.

5. The composite of claim 1, wherein the composite has a thickness, a length and a width, and wherein the length to thickness ratio is 100,000 or greater.

6. The composite of claim 5, wherein the width to thickness ratio is greater than 100,000.

7. The composite of claim 5, wherein the thickness of the composite is less than 500 nm, less than 200 nm, or less than 100 nm.

8. The composite of claim 1, wherein the carbon nanotubes of the composite are substantially uniformly distributed.

9. The composite of claim 1, wherein the carbon nanotubes of the composite are substantially aligned.

10. The composite of claim 1, wherein the carbon nanotubes of the composite are substantially disentangled.

11. The composite of claim 1, wherein the carbon nanotubes of the composite have aspect ratios of 1-100, 100-1000 or greater than 1000.

12. The composite of claim 1, wherein the composite has an optical transparency of greater than 60%, greater than 70%, greater than 80%, greater than 90%, greater than 95% or about 100%.

13. The composite of claim 1, wherein the composite has a surface resistance of less than 10⁶ Ω/□, less than 10⁵ Ω/□, less than 10⁴ Ω/□, less than 10³ Ω/□, less than 10² Ω/□, or less than 10 Ω/□.

14. The composite of claim 1, wherein the metal oxide formed from a non-silicate oxide.

15. The composite of claim 14, wherein the non-silicate oxide comprises oxides of Ti, Al, Zn, Zr, Nb, In, Sn, Ta, Hf, La, or combinations thereof.

16. The composite of claim 14, wherein the non-silicate oxide comprises an oxide of Ti, Al and Zn.

17. The composite of claim 1, wherein the network of carbon nanotubes and the network of amorphous metal oxide are continuous and porous.

18. The composite of claim 17, wherein the continuous and porous network of carbon nanotubes interpenetrates with the continuous and porous network of amorphous metal oxide to form a continuous and porous composite network.

19. The composite of claim 1, wherein the composite comprises a substrate selected from the group consisting of polymer film, glass substrate, polymer, polyester, polycarbonate, polyolefin, polyurethane, acrylate, epoxy, fluorocarbon elastomer, plastic, thermoplastic, polyethylene tetraphthalate, polyethylene naphthalate, and combinations thereof.

20. The composite of claim 1, wherein the composite comprises one or more layers containing the amorphous metal oxide.

21. The composite of claim 20, wherein the one or more layers containing the amorphous metal oxide have a surface resistance of greater than 10⁷ Ω/□, greater than 10¹⁰ Ω/□, greater than, greater than 10¹² Ω/□, or greater than 10²⁰ Ω/□.

22. The composite of claim 21, wherein the composite comprises a separate layer containing the carbon nanotubes, and wherein the surface resistance of the one or more layers containing the amorphous metal oxide to surface resistance of the layer containing the carbon nanotubes ratio is greater than 10, greater than 10², greater than 10⁵, or greater than 10⁷.

23. The composite of claim 1, wherein the composite further comprises a polymer.

24. The composite of claim 23, wherein the polymer is selected from a group consisting of polyester, polyurethane, polyolefin, fluoroplastic, fluoroelastomer, thermoplastic elastomer, polyvinylidene fluoride, polyvinyl fluoride, polychlorotrifluoroethylene, polyvinylalkyl vinyl ether, a melamine/acrylic copolymer, UV curable epoxy, a copolymer or polymer mixture, and combinations thereof.

25. A composition comprising a network of carbon nanotubes and a network of porous amorphous, non-silicate metal oxides, wherein said network of carbon nanotubes and said network of porous metal oxides form a composite, and wherein the composite has a thickness of less than 500 nm, less than 200 nm, or less than 100 nm.

26. The composition of claim 25, wherein the network of carbon nanotubes is porous and continuous and interpenetrates with the network of porous metal oxides to form a porous and continuous composite network.

27. The composition of claim 25, wherein the composition is deposited as a film on a substrate.

28. The composition of claim 27, wherein the substrate is selected from the group consisting of polymer film, glass substrate, polymer, polyester, polycarbonate, polyolefin, polyurethane, acrylate, epoxy, fluorocarbon elastomer, plastic, thermoplastic, polyethylene tetraphthalate, polyethylene naphthalate, and combinations thereof.

29. The composition of claim 25, further comprising a polymer.

30. The composition of claim 29, wherein the polymer is selected from a group consisting of polyester, polyurethane, polyolefin, fluoroplastic, fluoroelastomer, thermoplastic elastomer, polyvinylidene fluoride, polyvinyl fluoride, polychlorotrifluoroethylene, polyvinylalkyl vinyl ether, a melamine/acrylic copolymer, UV curable epoxy, a copolymer or polymer mixture, and combinations thereof.

31. A method of forming an electrically conductive and transparent film comprising:
providing an electrically conductive network of carbon nanotubes; and
depositing a non-silicate alkoxide in the form of a sol comprising an alcohol and an acid onto the network, wherein the metal alkoxide undergoes hydrolysis to be converted to a metal oxide.

32. The method of claim 31, further comprising air drying the film.

33. The method of claim 31, wherein the depositing of the metal alkoxide comprises dip coating the network into a solution containing the metal alkoxide.

34. The method of claim 31, further comprising heating the film at a temperature of between approximately 60 and 200 degrees Celsius.

35. The method of claim 31, wherein the heating is performed for more than 15 minutes, more than 30 minutes, more than 1 hour, more than 1.5 hours, more than 2 hours, more than 2.25 hours, more than 2.5 hours.

36. The method of claim 31, further comprising depositing a polymeric coating on the composite.

37. The method of claim 37, wherein the polymeric coating comprises polyester, polyurethane, polyolefin, fluoroplastic, fluoroelastomer, thermoplastic elastomer, polyvinylidene fluoride, polyvinyl fluoride, polychlorotrifluoroethylene, polyvinylalkyl vinyl ether, a melamine/acrylic copolymer, UV curable epoxy, a copolymer or polymer mixture, or combinations thereof.

38. The method of claim 37, wherein the polymeric coating is adhesive.

39. The method of claim 37, wherein the polymeric coating prevents degradation of the composite due to mechanical or physical stress.

40. The method of claim 37, wherein the polymeric coating has an index of refraction which matches adjacent layers.

41. The method of claim 32, wherein the depositing of the sol is repeated after the air drying.

42. The method of claim 31, wherein surface resistance of the film undergoes a less than 25% change upon exposure to temperatures of 80° C. or greater, electromagnetic radiation, UV radiation for more than 100 hours, a relative humidity of 15% or greater, physical stress, chemical stress, mechanical stress.

43. The composite of claim 42, wherein the surface resistance undergoes a less than 20% change, less than 15% change, less than 10% change, or less than 5% change.

44. The composite of claim 42, wherein the surface resistance undergoes no detectable or significant change.

45. The method of claim 31, wherein the non-silicate alkoxide comprises Ti, Al, Zn, Zr, Nb, In, Sn, Ta, Hf. La, or combinations thereof.

46. The method of claim 45, wherein the non-silicate alkoxide comprises Ti—Al—Zn.

47. The method of claim 31, wherein the metal oxide is amorphous.

48. A composite formed by the method of claim 31.

49. A method of patterning an electrically conductive and transparent coating comprising:
depositing a layer of carbon nanotubes onto a film;
selectively depositing a sol-gel solution onto a portion of the layer of carbon nanotubes;
heating the film comprising the carbon nanotubes and the sol-gel; and
removing a portion of the carbon nanotubes onto which the sol-gel was not deposited to form a pattern.
